(19) United States
(12) Patent Application Publication
(10) Pub. No.: US 2004/0017097 A1
(43) Pub. Date: Jan. 29, 2004

(54) Motor vehicle with a roof which can be opened and a process for opening it

(75) Inventors: Jean Paul Albert, Saint Pierre des Echaubrognes (FR); Francois De Gaillard, Mouilleron en pareds (FR); Sergio Viter Pocchiola, Mezzenile (IT); Koii Sumida, Hiroshima (JP); Sigeru Ueki, Higashihiroshima-City (JP)

Correspondence Address: NIXON PEABODY, LLP, 401 9TH STREET, NW, SUITE 900, WASINGTON, DC, 20004-2128, US

(73) Assignee: Webasto Vehicle Systems International GmbH, Stockdorf (DE)

(21) Appl. No.: 10/358,402

(22) Filed: Feb. 5, 2003

(30) Foreign Application Priority Data
Feb. 5, 2002 (DE) 102 04 666.2

(51) Int. Cl. B60J 7/06

(52) U.S. Cl. 296/219; 296/146.15

(57) ABSTRACT

A motor vehicle with a roof which can be opened, with a body (12) which forms a vehicle passenger compartment (14) which is bordered on its front and back end by a front window (16) and a rear window element (18), respectively, and on the sides of which body-mounted lengthwise roof members (20) extend from the front to back, the lengthwise roof members (20), the top edge (38) of the front window (16) and the top edge (34) of the rear window element (18) surrounding a roof opening (26), and with a folding convertible top (28) for selectively opening and closing the roof opening (26), has the top edge (34) of the rear window element (18) connected to the folding convertible top (28) and its bottom edge (36) attached to the body (12) to be able to swing around this edge (36) into the passenger compartment (14). Prior to swinging into the passenger compartment (14), the folding roof is displaceable onto the rear window element (18) so that it is moved into a storage space in the passenger compartment along with the window element on which it is located.

### BACKGROUND OF THE INVENTION

1. Field of the Invention

The invention relates to a motor vehicle with a roof which can be opened, with a body which forms a vehicle compartment which is bordered on its front and back ends by a front window and a rear window, respectively, and on the sides of which body-mounted lengthwise roof members extend from the front end to the back end, the lengthwise roof members, the top edge of the front window and the top edge of the rear window element enclosing the roof opening, and with a folding convertible top for selectively opening and closing the roof opening.

The invention relates furthermore to a process for opening the vehicle roof of a generic motor vehicle.

2. Description of Related Art

A motor vehicle of the initially is known, for example, from German patent specification DE 196 38 846 C2. There the fabric convertible top is divided into two sections, so that the front section runs from the front window to the rear roof break, and the rear section which contains the rear window extends from the rear roof break to the ledge of the body. The two sections can be opened separately. If the convertible top is completely opened, the two sections of the fabric convertible top are lowered into a corresponding holding shaft under the ledge.

In any case, in this configuration of the vehicle roof, a complex opening mechanism is necessary for opening and lowering the two sections. Handling of the rear window is also complicated. If the rear window itself is foldable, the fold break in the rear window leads to adverse effects on vision and the service life of the window. If the rear window is rigid, it imposes limitations on the type of folding of the entire fabric convertible top.

### SUMMARY OF THE INVENTION

The primary object of the present invention is to develop a motor vehicle of the initially mentioned type such that the above described problems are avoided, or at least diminished, especially to make provide such a motor vehicle roof with a simple and uncomplicated opening function for opening the motor vehicle roof.

This object is achieved by the top edge of the rear window element being connected to the folding convertible top and the bottom edge being attached to the body to be able to pivot around this edge. Furthermore, this object is achieved by a process in which the folding convertible top is folded during opening and is pushed onto the outside surface of the rear window element, and the rear window element is pivoted with the pushed-on convertible top into the passenger compartment so that, after pivoting the rear window element, the driver's view to the rear is essentially unobstructed. As a departure from the prior art the rear window element is not incorporated into the folding of the convertible top so that there is greater free space for its configuration.

In a preferred embodiment of the motor vehicle in accordance with the invention it is provided that the rear window element can be swung into the passenger compartment, preferably into a stowage space which is located behind seats of the motor vehicle. In this way, the rear window element can be stowed easily and in a space-saving manner. A complex mechanism for accommodation is not necessary.

In this connection, preferably, there is a drive for opening and closing the vehicle roof which is arranged and set up such that it folds the folding convertible top during opening and pushes it onto the outside surface of the rear window element.

In particular, the drive is advantageously arranged and set up to swing the rear window element together with the slipped-on convertible top into the passenger compartment after the folding convertible top has been slipped onto it. Thus, the vehicle roof, including the rear window area, can be completely opened without the rear window element being included in the folding of the convertible top. Rather, the folding of the convertible top and the pivoting of the rear window element interact in order to easily accommodate the two elements jointly in a space-saving manner.

In doing so, preferably, pivoting takes place into a position such that, after swinging of the rear window element into the passenger compartment, the driver's view to the rear is essentially unobstructed.

In one feasible embodiment of the motor vehicle in accordance with the invention, the rear window element is rigid and thus offers reliable support for the folded roof.

In one especially preferred development of the motor vehicle in accordance with the invention, it is provided that the rear window element contains a rear window frame and a rear window of transparent rigid material, especially of glass. Then, for example, a heating means for the rear window can be easily integrated.

In another feasible embodiment of the motor vehicle in accordance with the invention, the folding convertible top is a fabric convertible top.

In a process in accordance with the invention for opening the vehicle roof of a motor vehicle of the above described type, the folding convertible top is folded during opening and pushed onto the outside surface of the rear window element, and the rear window element is swung with the pushed-on convertible top into the passenger compartment so that after swinging the rear window element, the driver's view to the rear is essentially unobstructed.

Preferably, in the process in accordance with the invention, the folding of the convertible top, the pushing onto the rear window element and the swinging of the rear window element into the passenger compartment are effected by an electric drive.

The invention is based on the finding that the combination of a folding roof with a rear window element which can be pivoted into the vehicle interior enables an especially simple, economical and durable opening mechanism for a vehicle roof, especially in a cabriolet limousine.

The invention is explained by way of example with reference to the accompanying drawings using one preferred embodiment.

### BRIEF DESCRIPTION OF THE DRAWINGS

FIG. 1 is a perspective view, obliquely from above, of an embodiment of a motor vehicle in accordance with the invention with the vehicle roof closed;

FIG. 2 shows the motor vehicle from FIG. 1 with the vehicle roof completely opened; and

FIGS. 3(a) to 3(d) are highly schematic representations of four working positions when opening the roof from the FIG. 1 position and to the FIG. 2 position.

### DETAILED DESCRIPTION OF THE INVENTION

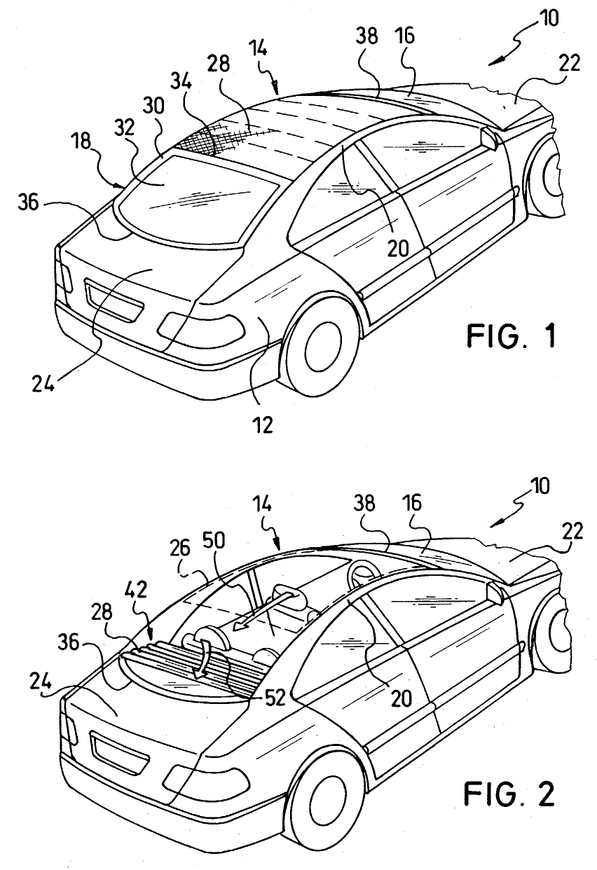

FIGS. 1 & 2 show the roof area of a four-door cabriolet sedan or limousine 10 in a perspective view obliquely from above, and in which the cabriolet sedan or limousine 10 has a body 12 which forms a passenger compartment 14. The passenger compartment 14 is bordered on its front end by the front window 16 and on its back end by the rear window element 18. Along the sides of the passenger compartment 14, lengthwise roof members 20 extend from the front part 22 of the body 12 (which is shown only partially) as far as the rear part 24 of the body 12.

The lengthwise roof members 20, the top edge 38 of the front window 16 and the top edge 34 of the rear window element 18 surround a roof opening 26 which is indicated in FIG. 2 by broken lines. The roof opening 26 can be closed by a folding fabric convertible top 28 (FIG. 1).

The rear window element 18 comprises a rear window frame 30 and a rear window 32 of transparent rigid material, in the embodiment, glass. The top edge 34 of the rear window element 18 is connected to the rear edge of the fabric convertible top 28. The rear window element 18 is pivotably attached at its rear edge 36 to the rear part 24 of the body 12.

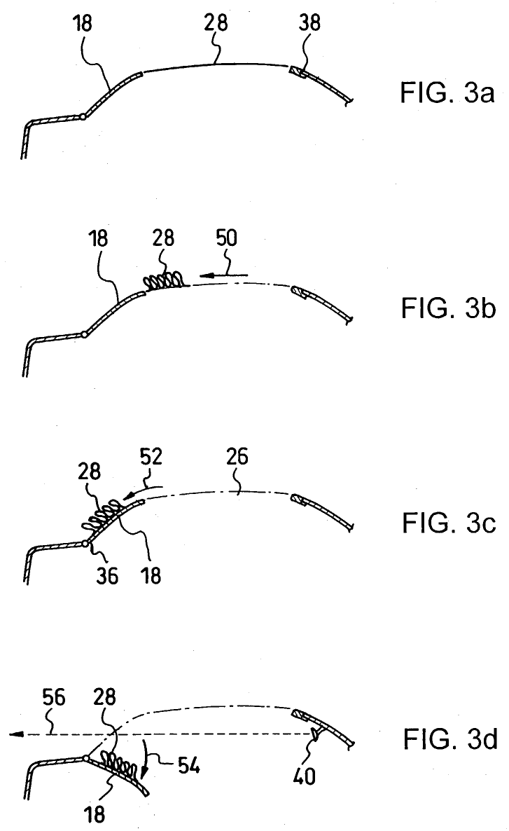

The opening process of the vehicle roof is shown in FIGS. 3(a) to 3(d) in highly schematic form in four working positions. The FIG. 3(a) position corresponds to the closed position shown in FIG. 1.

When the vehicle roof is opened, after actuation by the driver in the passenger compartment 14, first an electric drive (not shown) pushes the fabric convertible top 28 back from the top edge 38 of the front window in the direction of the arrow 50 and folds it up in the conventional manner (FIG. 3(b)). Then, the drive continues to push the folded fabric convertible top 28 in the direction of the arrow 52 obliquely downward onto the outside of the rigid rear window element 18 until it comes to rest completely on it as is shown in FIG. 3(c). The roof opening 26 is now completely cleared.

At this point, the drive unlocks the rear window element 18 and swings it, together with the slipped-on fabric convertible top 28, around its lower edge 36 into the interior of the passenger compartment 14, as is indicated by the arrow 54 in FIG. 3(d). Here, the rear window element is pivoted down to such an extent that the driver's view in rearward direction 56, via the rearview mirror 40, is not blocked. The vehicle roof, now including the area occupied beforehand by the rear window element 18, is completely opened.

The situation with the vehicle roof completely opened is shown in FIG. 2 in a perspective view which corresponds to FIG. 1. Here, it can also be recognized that the rear window element 18 with the convertible top 28 pushed on has been swung down into the stowage space 42 behind the back seats of the sedan or limousine 10.

It goes without saying that, to close the roof, the aforementioned steps are carried out in the reverse sequence. This means that the rear window element 18 with the convertible top 28 pushed on is swung up out of the passenger compartment 14 until it is locked into its upper position. Then, the drive pushes the convertible top 28 away from the rear window element 18 forward until it passes the top edge 34 of the rear window element 18. From there, the convertible top 28 is unfolded in the conventional manner over several bows, tightened and fixed in its closed position in the area of the top edge 38 of the front window 16 on the transversely running roof frame via a closing means (not shown).

The features of the invention disclosed in the above description, in the drawings and in the claims can be important for implementation of the invention individually and also in any combination.

What is claimed is:

1. Motor vehicle, comprising:
an openable roof,
a body which forms a vehicle passenger compartment having a roof opening which is bordered on front and back ends by top edges of a front window and a rear window element, respectively, and on lateral sides by body-mounted longitudinal roof members which extend from front to back along the passenger compartment, and
a folding convertible top for selectively opening and closing the roof opening,
wherein the top edge of the rear window element is connected to the folding convertible top and a bottom edge of the rear window element is pivotally attached to the body to swing around said bottom edge.

2. Motor vehicle in accordance with claim 1, wherein the rear window element is swingable into a stowage space in the passenger compartment

3. Motor vehicle in accordance with claim 2, wherein which said stowage space is located behind seats of the motor vehicle.

4. Motor vehicle in accordance with claim 2, the folding convertible top, during opening, is displaceable onto an outer surface of the rear window element.

5. Motor vehicle in accordance with claim 4, wherein a drive for opening and closing the vehicle roof.

6. Motor vehicle in accordance with claim 4, wherein the rear window element is swingable into the passenger compartment with the convertible top thereon.

7. Motor vehicle in accordance with claim 2, wherein a swung-in position of the rear window element in the passenger compartment provides a driver's view toward the rear of the vehicle is essentially unobstructed thereby.

8. Motor vehicle in accordance with claim 1, wherein the rear window element is rigid.

9. Motor vehicle in accordance with claim 8, wherein the rear window element comprises a rear window frame and a rear window of transparent rigid material.

10. Motor vehicle in accordance with claim 9, wherein the folding convertible top is a fabric convertible top.

11. Motor vehicle in accordance with claim 10, the folding convertible top, during opening, is displaceable onto an outer surface of the rear window element.

12. Motor vehicle in accordance with claim 1, wherein the folding convertible top is a fabric convertible top.

13. Process for opening the roof of a motor vehicle with an openable roof, a body having a vehicle passenger compartment with a roof opening which is bordered on front and back ends by top edges of a front window and a rear window element, respectively, and on lateral sides by body-mounted longitudinal roof members which extend from front to back along the passenger compartment, and a folding convertible top for selectively opening and closing the roof opening, comprising the steps of:
folding convertible top during opening,
pushed the folded convertible top onto an outer surface of the rear window element, and
swinging the rear window element with the convertible top thereon about a lower edge of the rear window element into a position within the passenger compartment that provides a driver's view to the rear is essentially unobstructed by the window element and folded convertible top.

14. Process in accordance with claim 13, in which the folding of the convertible top, the pushing of the convertible top onto the rear window element and the of the rear window element into the passenger compartment are effected by an electric drive.
